(19) United States
(12) Patent Application Publication
(10) Pub. No.: US 2007/0166500 A1
(43) Pub. Date: Jul. 19, 2007

(54) Dicing/die bonding film and method of manufacturing the same

(76) Inventors: Manabu Sutoh, Chiba Prefecture (JP); Yoshito Ushio, Chiba Prefecture (JP)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/584,475

(22) PCT Filed: Dec. 7, 2004
(86) PCT No.: PCT/JP04/18531

§ 371 Date: Jun. 23, 2006

(30) Foreign Application Priority Data
Dec. 24, 2003 (JP) 2003-426021

(51) Int. Cl. B32B 33/00; C09D 5/00

(52) U.S. Cl. 428/41.7; 428/448; 427/154

(57) ABSTRACT

A dicing/die bonding sheet is made by joining a base film (1) and a silicone based adhesive agent layer (3) through the medium of an undercoat layer (2). This all-in-one dicing/die bonding sheet exhibits superior long-term storage stability and prevents chip delamination during dicing.

### TECHNICAL FIELD

The present invention relates to a dicing/die bonding sheet used in the step of separating a semiconductor wafer, in particular, a semiconductor wafer with electronic circuits formed thereon, into individual chips by dicing.

### BACKGROUND ART

A semiconductor wafer of silicon etc. is processed into semiconductor devices in a series of steps including forming a plurality of electronic circuits on its surface, backgrinding the semiconductor wafer, on which the electronic circuits are formed, securing the semiconductor wafer to a base film and separating it into individual IC chips containing electronic circuits by cutting (dicing), securing (bonding) the above-mentioned IC chips to leadframes, and sealing the above-mentioned chips with resin.

When IC chips obtained by cutting a semiconductor wafer are secured to leadframes, the chips are secured to the chip mounting areas (mounting portions) of the leadframes using adhesive agents. If the above-mentioned adhesive agents are liquid, they are applied to the surface of the above-mentioned chip mounting areas or to the chips themselves in the form of droplets, but when droplets of such liquid adhesive agents are applied, it is difficult to precisely control the amount of the adhesive agents, which may be squeezed from under the chips if the chips are too small or may be insufficient if the chips are too large.

Thus, there was developed a method for securing IC chips to the chip mounting areas of leadframes using dry film-type adhesive agents pre-formed to uniform thickness. In one version of the method, a layer of film-type adhesive agent is formed in the chip mounting area and in another a layer of film-type adhesive agent is formed in advance on the chip itself. However, the method presents serious problems in terms of the cost and labor required to prepare semiconductor devices because an extra step of forming a layer of adhesive agent in the chip mounting area is required in the version of the method where a layer of film-type adhesive agent is formed in the chip mounting area and because the process of precisely forming an adhesive agent layer matching the shape of the chip in a predetermined position on the narrow surface of the chip mounting area is itself very difficult.

On the other hand, the above-mentioned problems do not arise in the version of the method where layers of film-type adhesive agents are formed in advance on IC chips. Namely, in the dicing step that precedes the die bonding step, a layer of adhesive agent can be provided on the surface of a semiconductor wafer at the point when the semiconductor wafer is secured to a base film, and, as a result, it is not necessary to form an adhesive agent layer during the die bonding step. In addition, in the dicing step, dicing a semiconductor wafer provided with an adhesive agent layer makes it possible to obtain chips with the adhesive agent layer precisely matching the shape of the chip surface.

For this reason, to make it possible have an adhesive agent layer on the surface of the chip in advance in the dicing step, the so-called all-in-one (or pre-cut type) dicing sheet has been developed, in which a layer of adhesive agent is formed on a base film; thus, for instance, Japanese Unexamined Patent Application Publication No. Hei 9-266183 offers a dicing/die bonding sheet provided with a layer of polyimide adhesive agent on a base film.

Because silicone based adhesive agents possess superior handling characteristics as well as excellent heat resistance and adhesive properties with respect to semiconductor wafers, etc., it is expected that they can be used for securing IC chips to leadframes in the die bonding step. However, when dicing is carried out using a dicing/die bonding sheet with a silicone based adhesive agent layer applied directly to a base film, the silicone based adhesive agent layer does adhere well to the semiconductor wafer, but it does not exhibit strong tack with respect to the base film, as a result of which the chip may sometimes peel from base film along with the silicone based adhesive agent layer (chip delamination). Chip delamination is an undesirable phenomenon because it reduces the efficiency of semiconductor device manufacture.

In addition, when a dicing/die bonding sheet is formed by applying a silicone based adhesive agent layer directly to a base film, in particular, to a base film of the type that has a thin acrylic based pressure sensitive adhesive agent layer formed on its surface, the bonding/tack forces at the interface between the silicone based adhesive agent and the acrylic based pressure sensitive adhesive agent layer increase over time, which may lead to problems with long-term storage stability.

It is an object of the present invention to eliminate the above-mentioned problems and in order to achieve it, the invention provides an all-in-one dicing/die bonding sheet that has excellent adhesive properties with respect to semiconductor wafers and base films, prevents chip delamination during the dicing process, and has excellent long-term storage stability.

### DISCLOSURE OF INVENTION

The object of the present invention is achieved by using a dicing/die bonding sheet provided with a base film, an undercoat layer formed on the base film, and a silicone based adhesive agent layer formed on the undercoat layer. Preferably, the silicone based adhesive agent layer can be stripped from the above-mentioned undercoat layer after bonding to a semiconductor wafer. The above-mentioned undercoat layer may be a laminate consisting of at least two layers. In addition, the surface area of the base film is preferably larger than the surface area of the semiconductor wafer, and, in particular, when the semiconductor wafer is round-shaped, a round-shaped base film with a larger diameter than the diameter of the semiconductor wafer is more preferable. In addition, the dicing/die bonding sheet of the present invention may be coated with a strippable protective layer.

The simplest way to prepare the dicing/die bonding sheet of the present invention is to carry out the steps of forming a silicone based adhesive agent layer and an undercoat layer on a base film.

In addition, the dicing/die bonding sheet of the present invention can be prepared by means of a first step, in which a silicone based adhesive agent layer and an undercoat layer are formed on stripping layer, a second step, in which a base film is applied to the surface of the above-mentioned undercoat layer, and a third step, in which the above-mentioned stripping layer is peeled off. In addition, in such a case, there may be further provided a fourth step, in which a strippable protective layer is formed on the above-mentioned silicone based adhesive agent layer.

It is also possible to prepare the dicing/die bonding sheet of the present invention by means of a first step, in which a silicone based adhesive agent layer and an undercoat layer are formed on a strippable protective layer, and a second step, in which a base film is applied to the surface of the above-mentioned undercoat layer.

### EFFECTS OF INVENTION

Because in the dicing/die bonding sheet of the present invention the silicone based adhesive agent layer is not in direct contact with the base film, the invention makes it possible to avoid the risk of various problems arising from such direct contact. For instance, the dicing/die bonding sheet of the present invention makes it possible to avoid the phenomenon of chip delamination, which is frequently encountered when using a dicing/die bonding sheet having a silicone based adhesive agent layer in direct contact with a base film. In addition, it permits an improvement in the long-term storage stability due to an increase in the peel strength at the contact interface between the base film and the silicone based adhesive agent layer over time, which is particularly noticeable when there is an acrylic based pressure sensitive adhesive agent layer formed on the surface of the base film.

Incidentally, while UV irradiation may be necessary in order to reduce the tack properties of the base film with respect to the adhesive agent layer when pieces of a semiconductor wafer are removed from the base film after dicing a semiconductor wafer using a dicing/die bonding sheet having its base film in direct contact with the adhesive agent layer, in case of the dicing/die bonding sheet of the present invention such UV irradiation is unnecessary because the base film is not adhesively bonded to the adhesive agent layer.

### BRIEF DESCRIPTION OF THE DRAWINGS

FIG. 1 contains a cross sectional view of an embodiment of the dicing/die bonding sheet of the present invention.

FIG. 2 contains a cross sectional view of another embodiment of the dicing/die bonding sheet of the present invention.

FIG. 3 contains a view of an embodiment of the preparing process of the dicing/die bonding sheet of the present invention.

FIG. 4 contains a view of another embodiment of the preparing process of the dicing/die bonding sheet of the present invention.

FIG. 5 contains a cross-sectional view, in which a semiconductor wafer is shown bonded to the dicing/die bonding sheet of the present invention and secured to a support ring (6).

FIG. 6 contains a cross-sectional view of a semiconductor wafer being diced on the dicing/die bonding sheet of the present invention.

FIG. 7 contains a cross-sectional view of the dicing/die bonding sheet of the present invention being stretched and IC chips being picked up from it.

FIG. 8 contains a cross-sectional view showing an example of a semiconductor device comprising IC chips provided with a silicone based adhesive agent layer obtained using the dicing/die bonding sheet of the present invention.

### REFERENCE NUMBERS

1: Base film

2: Undercoat layer

3: Silicone based adhesive agent layer

4: Protective layer

5: Stripping layer

6: Support ring

7: Semiconductor wafer

7a˜7f: IC chips

8: Mounting pad

9: Circuit wiring

10: Bonding wires

11: Heat-resistant resin

### DETAILED DESCRIPTION OF THE INVENTION

The dicing/die bonding sheet and method of its preparing of the present invention is specifically explained hereinbelow.

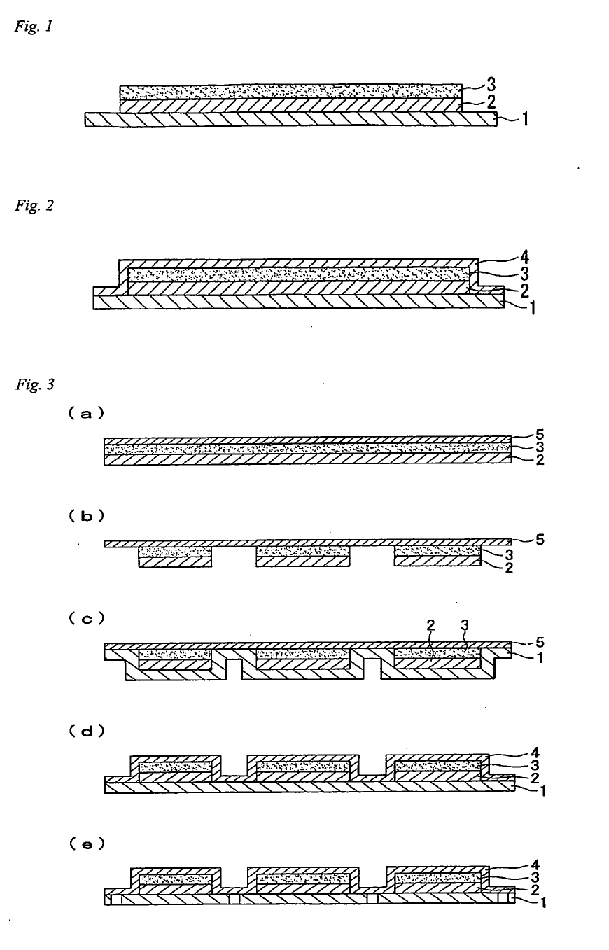

As shown in FIG. 1, the dicing/die bonding sheet of the present invention is made up of a base film (1), an undercoat layer (2), which is formed on the surface of the base film (1), and a silicone based adhesive agent layer (3), which is formed on the surface of the undercoat layer (2). Also, as shown in FIG. 2, the dicing/die bonding sheet of the present invention may be protected by a protective layer (4). From the standpoint of storage stability, the protective layer (4) preferably covers the entire surface of the silicone based adhesive agent layer (3), as shown in FIG. 1.

Materials that are most suitable for the base film (1) include materials stretchable in the length and width direction of the film, specifically, polyethylene film, polyvinyl chloride film, polybutene film, polybutadiene film, polyurethane film, polyester film, polyamide film, ethylene-vinyl acetate copolymer film, ethylene-(meth)acrylic acid copolymer film, ethylene-methyl (meth)acrylate copolymer film, ethylene-ethyl (meth)acrylate copolymer film, and other films made of soft resin. The base film (1) may be a laminate of several films. While there are no particular limitations concerning the thickness of the base film (1), it is usually about 10 to 300 μm, and, more preferably, about 50 to 200 μm.

A thin pressure sensitive adhesive agent layer may be formed on the surface of the base film (1), and common acrylic based, vinyl based, polyurethane based, silicone based, and polyester based pressure-sensitive adhesive agents can be used for the pressure sensitive adhesive agent layer. Among such commonly used pressure-sensitive adhesive agents, acrylic based pressure-sensitive adhesive agents are preferable from the standpoint of their tack properties.

The acrylic based pressure-sensitive adhesive agents contain acrylic homopolymers or copolymers as their main ingredients. The acrylic homopolymers are homopolymers of acrylic acid or acrylic acid esters and the acrylic copolymers are usually copolymers of a main monomer such as an acrylic acid ester having C₁˜C₁₈ alkyl groups in the ester moiety and an auxiliary copolymerizable monomer having functional groups such as hydroxyl groups, carboxyl groups, amino groups, etc. While there are no particular limitations concerning the molecular weight of the acrylic homopolymers or copolymers, their weight-average molecular weight is in the range of from 1.0×10⁵ to 1.0×10⁶, and especially preferably, in the range of from 4.0×10⁵ to 8.0×10⁵. In addition, the tack and cohesive forces can be controlled by adding an appropriate amount of cross-linking agents to the pressure-sensitive adhesive agent containing an acrylic copolymer with the above-mentioned functional groups. Polyvalent isocyanate compounds, polyvalent epoxy compounds, polyvalent aziridine compounds, metal chelate compounds, etc. are suggested as examples of the cross-linking agents. Such acrylic based pressure-sensitive adhesive agents may contain one, two, or more types of acrylic homopolymers or copolymers and may contain various additives.

Forming the above-mentioned pressure sensitive adhesive agent layer on the surface of the base film (1) permits better integration between the base film (1) and the undercoat layer (2). The thickness of the pressure sensitive adhesive agent layer is preferably in the range of from 1 to 50 μm, and, especially preferably, in the range of from 5 to 30 μm. In addition, when the base film (1) itself is made up of a material possessing excellent tack properties with respect to the undercoat layer (2), or when the base film (1) has a surface structure permitting it to be firmly bonded to the undercoat layer (2), the above-mentioned pressure sensitive adhesive agent layer may be unnecessary.

The undercoat layer (2) is adhesively bonded to the base film (1) and to the silicone based adhesive agent layer (3) with suitable strength, and, if necessary, possesses characteristics allowing it to be stripped from the silicone based adhesive agent layer (3) while maintaining its bond to the base film (1). While there are no particular limitations concerning the thickness of the undercoat layer (2), it is usually in the, range of from 1 to 100 μm, and, more preferably, in the range of from 5 to 50 μm.

While both films made of inorganic substances such as metals, metal oxides, etc. and films made of organic substances such as plastics, resins, rubber, etc. can be used for the undercoat layer (2), films made of organic substances are more preferable from the standpoint of their stretch properties, etc. Films made of polyethylene resins; polypropylene resins; fluororesins; polyethylene terephthalate (PET) resins; polybutylene terephthalate resins; polyether-imide resins; polysulfone resins; polyethersulfone (PES) resins; cellulose triacetate (TAC) resins, and other cellulosic resins; polyimide resins; polyester resins; polyether resins; polyetherketone resins; polyetheretherketone resins; epoxy resins; polyamide resins; polyoxymethylene resins; polyphenylene sulfide resins, and other organic resins are suggested as specific examples of the above-mentioned films made of organic substances. Although the undercoat layer is typically made up of only one of the above-mentioned films, if necessary, it may be a laminate of two or more identical or different films.

Oxygen atoms and/or sulfur atoms are preferably present on the surface of the undercoat layer (2) placed in contact with the silicone based adhesive agent layer (3). The oxygen atoms preferably form part of groups selected from the group comprising carbonyl, alkoxy, ester, and ether groups, and the sulfur atoms preferably form part of groups selected from the group comprising sulfone and thioether groups. The presence of oxygen atoms and/or sulfur atoms, and, in particular, the presence of groups comprising oxygen atoms and/or sulfur atoms as their constituent atoms on the surface of the undercoat layer (2) can be confirmed by means of elemental analysis, fluorescent X-ray analysis, X-ray microanalyzer analysis, infrared absorption analysis, ESCA analysis, etc. While there are no particular limitations concerning the content of such atoms or groups, the content should be detectable by the above-mentioned analytical methods. Substances used for the surface of the undercoat layer (2) that have suitable peeling properties with respect to the silicone based adhesive agent layer (3) and comprise oxygen atoms and/or sulfur atoms are exemplified by polyester resins, polyether resins, polyetheretherketone resins, epoxy resins, phenolic resins, polyoxymethylene resins, polyimide resins, polyamide resins, polyetherimide resins, cellulosic resins (cellulose diacetate, cellulose triacetate, etc.), polysulfone resins, polyether sulfone resins, and polyphenylene sulfide resins having such atoms in their constituent molecules.

On the other hand, polyethylene resins, polypropylene resins, fluororesins, and other organic substances that do not have oxygen atoms and/or sulfur atoms in their constituent molecules can be also used if oxygen atoms and/or sulfur atoms are introduced into the surface of such substances as constituent atoms by subjecting their surface to physical and/or chemical treatment such as corona discharge treatment, glow treatment, plasma treatment, ozone treatment, UV treatment, etc. under an oxygen atmosphere or under an atmosphere of sulfur atom-containing substances (sulfur dioxide, etc.).

In addition, if necessary, the surface of the undercoat layer (2) placed in contact with the silicone based adhesive agent layer (3) can be subjected to mold-release treatment. Mold release agents used for such mold release treatment include, among others, alkyd resin-based, silicone-based, fluorine-based, unsaturated polyester-based, polyolefin-based, and wax-based agents, with alkyd resin-based, silicone-based, and fluorine-based mold release agents being preferable, and alkyd resin-based mold release agents being particularly preferable.

Embodiments, in which the surface of the undercoat layer (2) is subjected to mold release treatment using the above-mentioned mold release agents, include, for instance, a method, in which a mold release agent is applied either as is, or diluted with a diluent, or in an emulsified state, to the surface using a gravure coater, a Meyer bar coater, an air knife coater, or a roll coater, etc. and cured at normal temperature, under heating, or using electron beams. In addition, a laminate of the undercoat layer (2) and a mold release agent may be formed by wet lamination, dry lamination, hot-melt lamination, hot-melt extrusion lamination, co-extrusion treatment, etc.

In the dicing/die bonding sheet of the present invention, the chip delamination phenomenon, in which chips peel off the base film (1) along with the silicone based adhesive agent layer (3) during dicing because of the insufficient bonding force between the silicone based adhesive agent layer (3) and the base film (1), can be avoided because the base film (1) and the silicone based adhesive agent layer (3) are joined through the medium of the undercoat layer (2) without being in direct contact with each other. In addition, when the silicone based adhesive agent layer (3) is applied directly to the base film (1), and especially when it is applied directly to a base film (1) of the type that has a thin acrylic based pressure sensitive adhesive agent layer formed on its surface, the noticeable increase in the bonding/tack forces between the base film (1) and the silicone based adhesive agent layer (3) over time is prevented and the long-term storage stability of the dicing/die bonding sheet can be improved.

In addition, despite the fact that Japanese Unexamined Patent Application Publication No. Hei 9-266183 describes the use of a highly heat-resistant polyimide adhesive agent layer in a bonding sheet used for wafer dicing, in which the polyimide adhesive agent layer and a soft film are joined together through the medium of a polyimide process film, the above-mentioned polyimide process film is intended to enable the use of different types of soft film by eliminating the impact that the high-polarity/high-boiling solvents utilized in the formation of polyimide adhesive agent layers have on soft films, which is clearly different from the present invention intended to eliminate potential problems associated with the use of the silicone based adhesive agent layer.

There are no particular limitations concerning the silicone based adhesive agent layer (3) so long as the materials used contain a silicone substance as the main ingredient, with suggested examples including elastomeric materials and clay-type materials. There are no particular limitations concerning the shape of the silicone based adhesive agent layer (3), but if practical considerations are taken into account, its thickness should preferably be in the range of from 1 to 5000 μm and especially in the range of from 5 to 1000 μm, with 5 to 100 μm being even more preferable. Such silicone based adhesive agents can be obtained, for instance, by purchasing FA60K2, FA3010 series, and FA2000 series films (all of the above are die attach films from Dow Corning Toray Silicone).

Although there are no particular limitations concerning the material of the protective layer (4) so long as it can be easily peeled off the silicone based adhesive agent layer (3) and base film (1), suitable materials typically include polyethylene film, polypropylene film, polystyrene film, polyvinyl chloride film, polyvinylidene chloride film, polyester film, polybutene film, polybutadiene film, polyurethane film, polyamide film, ethylene-vinyl acetate copolymer film, ethylene-(meth)acrylic acid copolymer film, ethylene-methyl (meth)acrylate copolymer film, ethylene-ethyl (meth)acrylate copolymer film, films made of fluororesins; polyethylene terephthalate (PET) resins; polybutylene terephthalate resins; polyetherimide resins; polysulfone resins; polyethersulfone (PES) resins; cellulose triacetate (TAC) resins, and other cellulosic resins; polyimide resins; polyester resins; polyether resins; polyetherketone resins; polyetheretherketone resins; epoxy resins; phenolic resins; polyamide resins; polyoxymethylene resins; polyphenylene sulfide resins, and other organic resins. The protective layer (4) may be a laminate of several films. While there are no particular limitations concerning the thickness of the protective layer (4), it is usually about 5 to 50 μm, and, more preferably, about 1 to 10 μm.

A thin pressure-sensitive adhesive layer may be formed on the surface of the side of the protective layer (4) that is in contact with the silicone based adhesive agent layer (3), and the same type of material as the acrylic-based adhesive agent formed on the surface of the base film (1) can be utilized for said pressure-sensitive adhesive layer.

On the other hand, if necessary, the surface of the side of the protective layer (4) that is in contact with the silicone based adhesive agent layer (3) may be subjected to release treatment, and the same type of treatment as the treatment conducted on the surface of the undercoat layer (2) can be carried out as such release treatment.

The dicing/die bonding sheet of the present invention can be prepared by successively forming an undercoat layer (2) and a silicone based adhesive agent layer (3) on the surface of a base film (1) using any applicable methods. In addition, it is preferable to further apply a protective layer (4) in order to maintain the adhesive properties of the silicone based adhesive agent layer (3) over time.

Preferably, the dicing/die bonding sheet of the present invention can be prepared by the following method schematically illustrated in FIG. 3 below. In accordance with this method, first of all, as shown in FIG. 3(a), a silicone based adhesive agent layer (3) and an undercoat layer (2) are formed on the surface of a stripping layer (5) made of any appropriate material. The silicone based adhesive agent layer (3) and undercoat layer (2) may be formed on the surface of the stripping layer (5) in succession or may be deposited on the surface of the stripping layer (5) in the form of a laminate in which they are mutually superposed in advance.

Next, as shown in FIG. 3(b), portions of the silicone based adhesive agent layer (3) and undercoat layer (2) successively formed on the surface of the stripping layer (5) are cut out using a cutter or punch such that the remaining portions of the silicone based adhesive agent layer (3) and undercoat layer (2) match the semiconductor wafer size. A portion of the cutter or punch may reach the surface of the stripping layer (5). In addition, the silicone based adhesive agent layer (3) and undercoat layer (2) deposited on the surface of the stripping layer (5) may be cut and shaped in advance to match the semiconductor wafer size, in which case the above-described cutting operation is unnecessary.

Next, as shown in FIG. 3(c), a base film (1) is applied on the side of the undercoat layer (2) and the stripping layer (5) is then peeled from the silicone based adhesive agent layer (3). By doing so, an all-in-one dicing/die bonding sheet is fabricated, in which a silicone based adhesive agent layer (3) is provided in a discontinuous manner on the surface of a base film (1) through the medium of an undercoat layer (2) interposed therebetween. In addition, if the base film (1) is in contact with the stripping layer (5), as shown in the figure, the stripping layer (5) should be peeled off in such a manner that the base film (1) itself is not stretched.

In addition, as shown in FIG. 3(d), after removing the stripping layer (5), it is preferable to coat the surface of the silicone based adhesive agent layer (3) with a protective layer (4). This will further improve the long-term storage stability of the dicing/die bonding sheet of the present invention. Also, as shown in FIG. 3(e), portions of the base film (1) located on the outside of the peripheral portions of the undercoat layer (2) and silicone based adhesive agent layer (3) may be cut out using a cutter or a punch so as to separate the base film (1) into sections larger than the semiconductor wafer size. This makes it possible to efficiently produce a plurality of dicing/die bonding sheets.

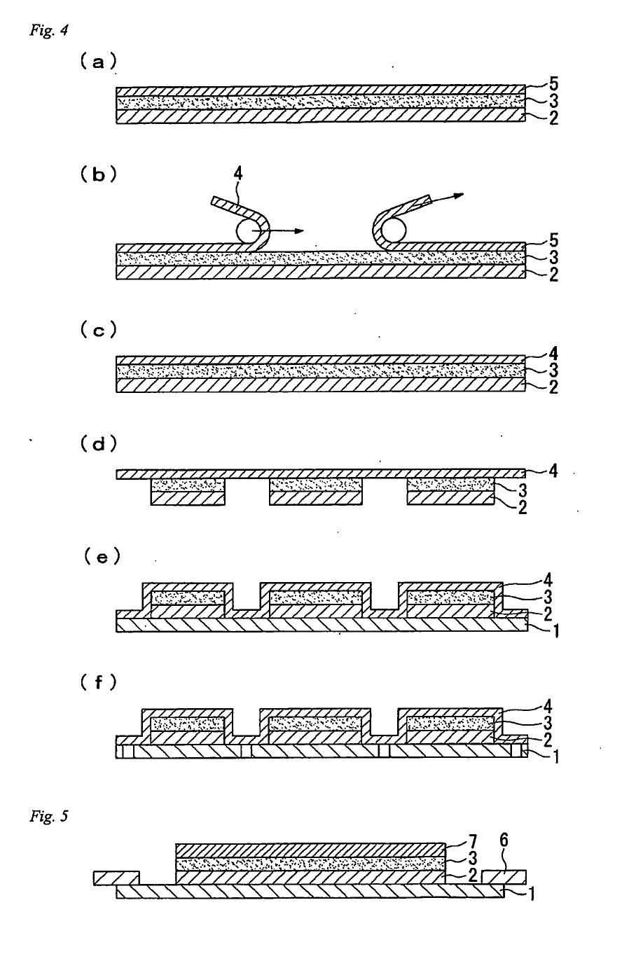

In addition, the dicing/die bonding sheet of the present invention can also be prepared by a method schematically illustrated in FIG. 4 below. In accordance with the method, first of all, as shown in FIG. 4(a), a silicone based adhesive agent layer (3) and an undercoat layer (2) are formed on the surface of a stripping layer (5). The silicone based adhesive agent layer (3) and undercoat layer (2) may be formed on the surface of the stripping layer (5) successively or may be deposited on the surface of the stripping layer (5) in the form of a laminate in advance.

Next, as shown in FIG. 4(b), the stripping layer (5) is peeled off, after which a protective layer (4) is deposited on the surface of the silicone based adhesive agent layer (3) using, for instance, an EM coater. A laminate, such as the one shown in FIG. 4(c), is obtained as a result. In the same manner as in FIG. 3, this further improves the long-term storage stability of the dicing/die bonding sheet of the present invention.

Next, as shown in FIG. 4(d), portions of the successively formed silicone based adhesive agent layer (3) and undercoat layer (2) are cut out using a cutter or a punch such that the remaining portions of the silicone based adhesive agent layer (3) and undercoat layer (2) match the semiconductor wafer size. A portion of the cutter or punch may reach the surface of the protective layer (4).

Next, as shown in FIG. 4(e), a base film (1) is applied to the undercoat layer (2). By doing so, an all-in-one dicing/die bonding sheet can be obtained, in which a silicone based adhesive agent layer (3) is provided on the surface of a base film (1) through the medium of an undercoat layer (2) interposed therebetween. Furthermore, as shown in the figure, it is preferable to bring the protective layer (4) in contact with the base film (1) such that the entire surface of the silicone based adhesive agent layer (3) is insulated from the outside environment. Unlike the method illustrated in FIG. 3, this preparing method prevents the risk of stretching the base film (1) during the peeling step because there is no step, in which the stripping layer (5) is peeled from the base film (1). Therefore, the risk of damaging the stretchability and other mechanical characteristics necessary for dicing tape can be avoided.

In addition, as shown in FIG. 4(f), portions of the base film (1) spaced away from the peripheral portions of the undercoat layer (2) and silicone based adhesive agent layer (3) may be cut out using a cutter or a punch so as to form the base film (1) into discontinuous sections larger than the semiconductor wafer size. This makes it possible to efficiently produce a plurality of dicing/die bonding sheets.

The dicing/die bonding sheet of the present invention can be used in the following manner.

When a semiconductor wafer is diced using the dicing/die bonding sheet of the present invention to prepare semiconductor devices from the resultant chips, first of all, as shown in FIG. 5, the edges of the base film (1) of the dicing/die bonding sheet are secured to a support ring (6) of a dicing machine and the semiconductor wafer (7) is bonded to the silicone based adhesive agent layer (3) of the same sheet. Depending on the type of the silicone based adhesive agent layer (3), the bonding of the semiconductor wafer to the silicone based adhesive agent layer (3) may be carried out under heating. In addition, the base film (1) may be secured to the support ring (6) after bonding the semiconductor wafer (7) to the silicone based adhesive agent layer (3). Also, a pressure-sensitive adhesive layer used for the support ring is preferably formed on the edges of the base film (1) in order to facilitate the securing of the dicing/die bonding sheet to the support ring (6).

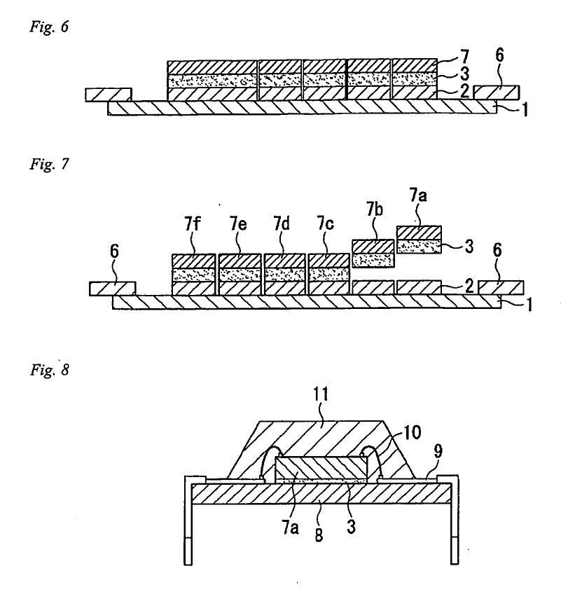

Next, as shown in FIG. 6, IC chips are fabricated by cutting the semiconductor wafer (7) along with the silicone based adhesive agent layer (3) using a cutting tool such as a dicing saw, etc. (not shown). Although at such time the cutting depth parameter is set appropriately so as to cut the semiconductor wafer (7) and silicone based adhesive agent layer (3), there is no need to adjust it in such a precise fashion, because, as shown in the figure, the undercoat layer (2) may be cut, too, and notches may be formed by the cutting tool in certain portions of the base film (1) as well.

Also, when the base film (1) is stretched by expanding the support ring (6), the spaces between the individual chips become larger and it is easy to pick them up.

Next, as shown in FIG. 7, the individual IC chips (7a)˜(7f), along with the silicone based adhesive agent layer (3) adhered thereto, are picked up from the surface of the undercoat layer (2) using a die collet or another pickup tool (not shown). The adhesive strength between the IC chips (7a)˜(7f) and the silicone based adhesive agent layer (3) is higher than the adhesive strength between the silicone based adhesive agent layer (3) and the undercoat layer (2).

As shown in FIG. 8, an IC chip thus obtained (e.g. (7a)), which is provided with a silicone based adhesive agent layer, is bonded and secured to the mounting pad of a leadframe through the medium of the silicone based adhesive agent layer (3) and, if necessary, is further subjected to heat treatment. The heat treatment temperature is typically not higher than 200° C. Bonding wires (10) are then used to connect the IC chip (7a) to circuit wiring (9) linked to external leads. The mounting pad (8) can be made up of ceramics, glass, epoxy resin, polyimide resin, phenolic resin, bakelite resin, melamine resin, glass fiber-reinforced epoxy resin, etc. The circuit wiring (9) can be made of gold, copper, aluminum, silver palladium, indium tin oxide (ITO), etc. The bonding wires (10) can be made of gold, copper, aluminum, etc.

Then, finally, as shown in FIG. 8, the IC chip (7a) is sealed in resin using heat-resistant resin (11). Appropriate epoxy resins, phenolic resins, and polyphenylene sulfide resins can be used as the heat resistant resin.

### EXAMPLES

The dicing/die bonding sheet of the present invention and preparing method thereof will be now explained in detail by referring to application examples.

### Application Example 1

A die attach film (FA60K2 from Dow Corning Toray Silicone) with a three-layer structure comprising film A and film B bonded to the two sides of a silicone based adhesive agent layer was cut into round pieces with a diameter of 150 mm to a depth extending from film B on one side to film A on the other side, whereupon the round portions with a diameter of 150 mm were left in place and the rest was removed from the half-cut film A.

Next, a base film (UHP-110B from Denki KagakLi Kogyo Kabushiki Kaisha) having a pressure-sensitive adhesive material layer formed thereon was adhered to film B, which had been shaped into round pieces with a diameter of 150 mm, and then cut into concentric round pieces with a diameter of 190 mm to a depth extending from the base film to film A, whereupon the round portions were left in place and the peripheral portions were removed.

A composite film comprising a die attach film and a base film, in which film B was interposed between the silicone based adhesive agent layer and the base film, was obtained as a result.

The peel strength between the silicone based adhesive agent layer and film B was 2.5 N/m and the peel strength between the base film and film B was 125 N/m.

After subjecting the film to thermal aging at 50° C. for a predetermined time, changes in the peel strength between the silicone based adhesive agent layer and film B were examined. The results are shown in Table 1.

Next, film A was removed from the composite film, a support ring was attached to the periphery of the base film, and a 6-inch silicon wafer was attached to the silicone based adhesive agent layer by applying pressure at 80° C. After that, the wafer was diced into chips with a chip size of 5 mm×5 mm using a dicing machine DAD-2H/6T from Disco Corporation with an NBC-ZH2050-SE (27HEEE) blade at a feed speed of 40 mm/sec and a rotational speed of 30,000 rpm. The silicone based adhesive agent layer was subjected to dicing together with the silicon wafer. No chip delamination during dicing was noted.

Immediately after dicing, the silicon wafer chips diced together with the silicone based adhesive agent layer were picked up by expanding the base film and adhered to UPIREX 125S from Ube Industries, Ltd. by applying a pressure of 1 MPa for 1 sec at 150° C., and their adhesive properties were examined. In the same manner, after dicing, the chips were subjected to thermal aging at 50° C. for 144 hrs., picked up, and adhered to UPIREX 125S from Ube Industries, Ltd. by applying a pressure of 1 MPa for 1 sec at 150° C., and their adhesive properties were examined. The results are shown in Table 1.

### Comparative Example 1

A die attach film (FA60K2 from Dow Corning Toray Silicone) with a three-layer structure, in which film A and film B were bonded to the two sides of a silicone based adhesive agent layer, was cut into round pieces with a diameter of 150 mm to a depth extending from film B on one side to film A on the other side, whereupon the round portions with a diameter of 150 mm were left in place and the rest was removed from the half-cut film A.

Next, film B shaped into round pieces with a diameter of 150 mm was removed, a base film (UHP-110B from Denki Kagaku Kogyo Kabushiki Kaisha) having a pressure-sensitive adhesive material layer formed thereon was adhered to the silicone based adhesive agent layer, and the film was cut into concentric round pieces with a diameter of 190 mm to a depth extending from the base film to film A, whereupon the round portions were left in place and the peripheral portions were removed.

A composite film comprising a die attach film and a base film, in which the silicone based adhesive agent layer was in direct contact with the base film, was obtained as a result. The peel strength between the silicone based adhesive agent layer and the base film was 14.7 N/m.

After subjecting the film to thermal aging at 50° C. for a predetermined time, changes in the peel strength between the silicone based adhesive agent layer and the base film were examined. The results are shown in Table 1.

Next, film A was removed from the composite film, a support ring was attached to the periphery of the base film, and a 6-inch silicon wafer was attached to the silicone based adhesive agent layer by applying pressure at 80° C. After that, the wafer was diced into chips with a chip size of 5 mm×5 mm using a dicing machine DAD-2H/6T from Disco Corporation with an NBC-ZH2050-SE (27HEEE) blade at a feed speed of 40 mm/sec and a rotational speed of 30,000 rpm. The silicone based adhesive agent layer was subjected to dicing together with the silicon wafer. No chip delamination during dicing was noted.

Immediately after dicing, the silicon wafer chips diced together with the silicone based adhesive agent layer were picked up by expanding the base film and adhered to UPIREX 125S from Ube Industries, Ltd. by applying a pressure of 1 MPa for 1 sec at 150° C., and their adhesive properties were examined. In the same manner, after dicing, the chips were subjected to thermal aging at 50° C. for 144 hrs., picked up, and adhered to UPIREX 125S from Ube Industries, Ltd. by applying a pressure of 1 MPa for 1 sec at 150° C., and their adhesive properties were examined. The results are shown in Table 1.

### Application Example 2

A die attach film (FA3010-25T from Dow Coming Toray Silicone) with a three-layer structure, in which film A and film B were bonded to the two sides of a silicone based adhesive agent layer, was cut into round pieces with a diameter of 150 mm to a depth extending from film B on one side to film A on the other side, whereupon the round portions with a diameter of 150 mm were left in place and the rest was removed from the half-cut film A.

Next, a base film (UHP-110B from Denki Kagaku Kogyo) having a pressure-sensitive adhesive material layer formed thereon was adhered to film B, which had been shaped into round pieces with a diameter of 150 mm, and then cut into concentric round pieces with a diameter of 190 mm to a depth extending from the base film to film A, whereupon the round portions were left in place and the peripheral portions were removed.

A composite film comprising a die attach film and a base film, in which film B was interposed between the silicone based adhesive agent layer and the base film, was obtained as a result.

The peel strength between the silicone based adhesive agent layer and film B was 1.8 N/m and the peel strength between the base film and film B was 125 N/m.

After subjecting the film to thermal aging at 50° C. for a predetermined time, changes in the peel strength between the silicone based adhesive agent layer and film B were examined. The results are shown in Table 1.

Next, film A was removed from the composite film, a support ring was attached to the periphery of the base film, and a 6-inch silicon wafer was attached to the silicone based adhesive agent layer by applying pressure at 80° C. After that, the wafer was diced into chips with a chip size of 5 mm×5 mm using a dicing machine DAD-2H/6T from Disco Corporation with an NBC-ZH2050-SE (27HEEE) blade at a feed speed of 40 mm/sec and a rotational speed of 30,000 rpm. The silicone based adhesive agent layer was subjected to dicing together with the silicon wafer. No chip delamination during dicing was noted.

Immediately after dicing, the silicon wafer chips diced together with the silicone based adhesive agent layer were picked up by expanding the base film and adhered to UPIREX 125S from Ube Industries, Ltd. by applying a pressure of 1 MPa for 1 sec at 150° C., and their adhesive properties were examined. In the same manner, after dicing, the chips were subjected to thermal aging at 50° C. for 144 hrs., picked up, and adhered to UPIREX 125S from Ube Industries, Ltd. by applying a pressure of 1 MPa for 1 sec at 150° C., and their adhesive properties were examined. The results are shown in Table 1.

### Comparative Example 2

A die attach film (FA3010-25T from Dow Coming Toray Silicone) with a three-layer structure, in which film A and film B were bonded to the two sides of a silicone based adhesive agent layer, was cut into round pieces with a diameter of 150 mm to a depth extending from film B on one side to film A on the other side, whereupon the round portions with a diameter of 150 mm were left in place and the rest was removed from the half-cut film A.

Next, film B shaped into round pieces with a diameter of 150 mm was removed, a base film (UHP-110B from Denki Kagaku Kogyo Kabushiki Kaisha) having a pressure-sensitive adhesive material layer formed thereon was adhered to the silicone based adhesive agent layer, and the film was cut into concentric round pieces with a diameter of 190 mm to a depth extending from the base film to film A, whereupon the round portions were left in place and the peripheral portions were removed.

A composite film comprising a die attach film and a base film, in which the silicone based adhesive agent layer was in direct contact with the base film, was obtained as a result. The peel strength between the silicone based adhesive agent layer and the base film was 8.42 N/m.

After subjecting the film to thermal aging at 50° C. for a predetermined time, changes in the peel strength between the silicone based adhesive agent layer and the base film were examined. The results are shown in Table 1.

Next, film A was removed from the composite film, a support ring was attached to the periphery of the base film, and a 6-inch silicon wafer was attached to the silicone based adhesive agent layer by applying pressure at 80° C. After that, the wafer was diced into chips with a chip size of 5 mm×5 mm using a dicing machine DAD-2H/6T from Disco Corporation with an NBC-ZH2050-SE (27HEEE) blade at a feed speed of 40 mm/sec and a rotational speed of 30,000 rpm. The silicone based adhesive agent layer was subjected to dicing together with the silicon wafer. No chip delamination during dicing was noted.

Immediately after dicing, the silicon wafer chips diced together with the silicone based adhesive agent layer were picked up by expanding the base film and adhered to UPIREX 125S from Ube Industries, Ltd. by applying a pressure of 1 MPa for 1 sec at 150° C., and their adhesive properties were examined. In the same manner, after dicing, the chips were subjected to thermal aging at 50° C. for 144 hrs., picked up, and adhered to UPIREX 125S from Ube Industries, Ltd. by applying a pressure of 1 MPa for 1 sec at 150° C., and their adhesive properties were examined. The results are shown in Table 1.

### Comparative Example 3

A die attach film (FA3010-25T from Dow Coming Toray Silicone) with a three-layer structure, in which film A and film B were bonded to the two sides of a silicone based adhesive agent layer, was cut into round pieces with a diameter of 150 mm to a depth extending from film B on one side to film A on the other side, whereupon the round portions with a diameter of 150 mm were left in place and the rest was removed from the half-cut film A.

Next, film B shaped into round pieces with a diameter of 150 mm was removed, a base film (polyolefin film from Tamapoly Co., Ltd.), which did not have a pressure-sensitive adhesive material layer formed thereon, was adhered to the silicone based adhesive agent layer, and the film was cut into concentric round pieces with a diameter of 190 mm to a depth extending from the base film to film A, whereupon the round portions were left in place and the peripheral portions were removed.

A composite film comprising a die attach film and a base film, in which the silicone based adhesive agent layer was in direct contact with the base film, was obtained as a result. The peel strength between the silicone based adhesive agent layer and the base film was 0.74 N/m.

After subjecting the film to thermal aging at 50° C. for a predetermined time, changes in the peel strength between the silicone based adhesive agent layer and the base film were examined. The results are shown in Table 1.

Next, film A was removed from the composite film, a support ring was attached to the periphery of the base film, and a 6-inch silicon wafer was attached to the silicone based adhesive agent layer by applying pressure at 80° C. After that, the wafer was diced into chips with a chip size of 5 mm×5 mm using a dicing machine DAD-2H/6T from Disco Corporation with an NBC-ZH2050-SE (27HEEE) blade at a feed speed of 40 mm/sec and a rotational speed of 30,000 rpm. The silicone based adhesive agent layer was subjected to dicing together with the silicon wafer. Serious chip delamination was observed during dicing.

Immediately after dicing, the silicon wafer chips diced together with the silicone based adhesive agent layer were picked up by expanding the base film and adhered to UPIREX 125S from Ube Industries, Ltd. by applying a pressure of 1 MPa for 1 sec at 150° C., and their adhesive properties were examined. In the same manner, after dicing, the chips were subjected to thermal aging at 50° C. for 144 hrs., picked up, and adhered to UPIREX 125S from Ube Industries, Ltd. by applying a pressure of 1 MPa for 1 sec at 150° C., and their adhesive properties were examined. The results are shown in Table 1.

TABLE 1

| | Examples | | | | |
|---|---|---|---|---|---|
| | The Present Invention | | Comparative Examples | | |
| | Application | Application | Comparative | Comparative | Comparative |
| Parameters | Example 1 | Example 2 | Example 1 | Example 2 | Example 3 |
| Peel strength | | | | | |
| (N/m) | | | | | |
| Initial | 2.5 | 1.8 | 14.7 | 8.4 | 0.7 |
| 50° C., 1 hour | — | — | 21.6 | 17.7 | — |
| later | | | | | |
| 50° C., 8 hours | — | — | 26.5 | 23.1 | — |
| later | | | | | |
| 50° C., 48 | — | — | 65.9 | 111.8 | — |
| hours later | | | | | |
| 50° C., 72 | — | — | 111.8 | 125.6 | — |
| hours later | | | | | |
| 50° C., 144 | 3.3 | 2.2 | 153.0 | No data | 1.0 |
| hours later | | | | | |
| Adhesion | | | | | |
| Initial | Excellent | Excellent | Excellent | Excellent | Excellent |
| 50° C., 144 | Excellent | Excellent | Poor | Poor | Excellent |
| hours later | | | | | |

As can be seen from Table 1, providing an undercoat layer (film B) between the base film and the silicone based adhesive agent layer prevents chip delamination and makes it possible to improve long-term storage stability.

### INDUSTRIAL APPLICABILITY

The dicing/die bonding sheet of the present invention has excellent adhesive properties with respect to semiconductor wafers and base films, prevents chip delamination during the dicing process, and has excellent long-term storage stability. Therefore, the dicing/die bonding sheet of the present invention is possible to improve the yield of semiconductor devices in process of their production.

1. A dicing/die bonding sheet adhesively bonded to a semiconductor wafer prior to the dicing of said semiconductor wafer, wherein said dicing/die bonding sheet is provided with a base film, an undercoat layer formed on said base film, and a silicone based adhesive agent layer formed on said undercoat layer and having an adhesive surface adhesively bonded to said semiconductor wafer.

2. The dicing/die bonding sheet according to claim 1, wherein said silicone based adhesive agent layer can be stripped from said undercoat layer after bonding to said semiconductor wafer.

3. The dicing/die bonding sheet according to claim 1, wherein said undercoat layer is a laminate made up of at least two layers.

4. The dicing/die bonding sheet according to claim 1, wherein said base film has a surface area that is not less than said semiconductor wafer.

5. The dicing/die bonding sheet according to claim 1, which is coated with a strippable protective layer.

6. A method of preparing the dicing/die bonding sheet according to claim 1, which includes the step of forming the undercoat layer and the silicone based adhesive agent layer on the base film.

7. The method of preparing a dicing/die bonding sheet according to claim 1, which includes the step of forming the silicone based adhesive agent layer and the undercoat layer on a stripping layer, the step of applying the base film to a surface of the undercoat layer, and the step of peeling off the stripping layer.

8. The method of preparing a dicing/die bonding sheet according to claim 7, which further includes the step of forming a strippable protective layer on the silicone based adhesive agent layer after the step of peeling off the stripping layer.

9. The method of preparing a dicing/die bonding sheet according to claim 5, which includes the step of forming the silicone based adhesive agent layer and the undercoat layer on the strippable protective layer and the step of applying the base film to a surface of the undercoat layer.

10. The dicing/die bonding sheet according to claim 2, wherein said undercoat layer is a laminate made up of at least two layers.

11. The dicing/die bonding sheet according to claim 2, wherein said base film has a surface area that is not less than said semiconductor wafer.

12. The dicing/die bonding sheet according to claim 3, wherein said base film has a surface area that is not less than said semiconductor wafer.

13. The dicing/die bonding sheet according to claim 10, wherein said base film has a surface area that is not less than said semiconductor wafer.

14. The dicing/die bonding sheet according to claim 2, which is coated with a strippable protective layer.

15. The dicing/die bonding sheet according to claim 3, which is coated with a strippable protective layer.

16. The dicing/die bonding sheet according to claim 4, which is coated with a strippable protective layer.

17. The dicing/die bonding sheet according to claim 10, which is coated with a strippable protective layer.

18. The dicing/die bonding sheet according to claim 11, which is coated with a strippable protective layer.

19. The dicing/die bonding sheet according to claim 12, which is coated with a strippable protective layer.

20. The dicing/die bonding sheet according to claim 13, which is coated with a strippable protective layer.
